(19) United States
(12) Patent Application Publication
(10) Pub. No.: US 2015/0128720 A1
(43) Pub. Date: May 14, 2015

(54) SYSTEM AND METHOD FOR MONITORING STATE OPERATION USING FLOW REGULATOR FEEDBACK CONTROL

(71) Applicant: Newport Controls, Irvine, CA (US)

(72) Inventors: Howard Isham Royster, Lafayette, CA (US); Michael J. Rogerson, Irvine, CA (US)

(73) Assignee: Newport Controls, Irvine, CA (US)

(21) Appl. No.: 14/078,408

(22) Filed: Nov. 12, 2013

(51) Int. Cl. G01F 15/00

(52) U.S. Cl. CPC G01F 15/005
USPC 73/861

(57) ABSTRACT

A system and method to monitor and/or control the operation of a fluid transferring system that does not require the use of a realtime fluid sensor. The system relies on a feedback control mechanism that provides the operating conditions of the flow regulator. Based on the information relating to the state of the flow regulator, the system is able to provide information regarding the fluid state such as flow rate. This is accomplished through the use of pre-recorded correlations between flow regulator settings and resulting fluid conditions.

### BACKGROUND OF THE INVENTION

1. Field of the Invention

The present invention relates to an improved system and method to control the flow rate of a fluid.

2. Discussion of the Related Art

Flow control is an important feature in many different applications including industrial applications, medical devices, and other commodities. Accurate flow control often requires various flow and pressure sensors to closely monitor the amount of fluid flowing through a system and the pressure created by such flow. Some examples of flow meters include vane style meters, laminate flow sensors, float style sensors, paddle wheel, magnetic sensors, positive displacement sensors, propeller type sensors, target sensors, turbines, ultrasonic sensors, and others. The accuracy of these sensors varies and their applicability is generally geared to specific situations.

Although these sensors can provide different ways to measure and thus control fluid flow rates, they also present some issues. Their implementation can be expensive. Also, the instability of the fluid dynamics may affect the accuracy of the sensor readings. For example fluid turbulence caused by pipe fittings or pipe diameter changes may affect the reading of a flow meter. The flow meters also often require periodic maintenance and calibration as they may be affected by the prolonged exposures to the flow. The accuracy of the sensor reading may also be affected by the location of the sensor. Also, in some instances it may be undesirable to have these sensors in direct contact with the fluid. For example, some flow meters may not be able to record the proper reading when the fluid contains solid particles. Also, some fluids may be very corrosive or chemically reactive that preclude the use of some types of flow meters.

Thus, while flow meters have been developed to address different situations in different fields of applications, there are still many considerations that can make the implementation of a flow meter a complex and potentially expensive problem. In view of these drawbacks, a need exists for a simpler, reliable, and efficient system and method to control flow rates of fluids and easily relate information regarding the system conditions under various flow rates.

### SUMMARY OF THE INVENTION

Accordingly, the present invention is directed to system and method for monitoring state operation using flow regulator feedback control that substantially obviates one or more of the problems due to limitations and disadvantages of the related art.

An advantage of the present invention is to provide a simple and cost effective way to control flow of a fluid.

Another advantage of the present invention is to provide a system capable of relaying information regarding the system at a given flow rate.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for monitoring the conditions of a fluid being transferred comprising a flow regulator and a storage device comprising one or more pre-recorded correlations between settings of the flow regulator and conditions of the fluid being transferred, wherein the conditions of the fluid being transferred are monitored based on the settings of the flow regulator using the one or more correlations.

In another aspect of the present invention, a method of monitoring the conditions of a fluid being transferred comprising providing a storage device comprising one or more pre-recorded correlations between settings of a flow regulator and conditions of the fluid being transferred, sensing a setting of the flow regulator during operation, and determining the conditions of the fluid being transferred based on the settings of the flow regulator using the one or more correlations.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIGS. 1A and 1B provide exemplary correlation tables.

FIG. 2 is a schematic representation of an exemplary embodiment having two valves each operated by a motor and each monitored by a sensor.

FIG. 3 is a schematic representation of the controller system.

FIG. 4 is a schematic representation of the control and/or monitoring system for a two valve embodiment.

FIG. 5 illustrates an exemplary controller.

FIG. 6 is a diagram of an exemplary embodiment of a valve sensor.

FIG. 7 is a schematic representation of the connections and data flow between at least one exemplary sensor, monitoring electronics, and signal multiplexing electronics.

FIG. 8 is hardware block diagram of an exemplary embodiment of a valve sensor set-up.

FIG. 9 is a diagram of an exemplary embodiment using three motor pumps.

FIG. 10 is a diagram of an exemplary embodiment using a variable motor pump.

FIG. 11 is diagram of an exemplary embodiment using a pressure flow device to operate and/or monitor the valve opening.

FIG. 12 is a diagram of an exemplary embodiment having a solenoid operated valve.

### DETAILED DESCRIPTION OF THE ILLUSTRATED EMBODIMENTS

Reference will now be made in detail to an embodiment of the present invention, example of which is illustrated in the accompanying drawings.

Exemplary embodiments provide system and method to monitor and/or control fluid flow using a feedback that provides information regarding the flow regulator operation rather than direct measurements of the fluid, such as flow rate, pressure, turbulence and the like.

This monitoring and/or control may be achieved by using a set of correlations between different input settings, flow regulator settings and various prerecorded characteristics or information about the system and its operation such as, for example, flow rates.

The system may be easily adapted to work with any type of fluid independent of viscosity or solid contents. In exemplary embodiments the fluid may be water. In other exemplary embodiments, the fluid may be oil or petroleum. In yet other exemplary embodiments, the fluid may be air. In another exemplary embodiment the fluid may contain solids, such as waste water. In other exemplary embodiments, the fluid may be a purified liquid. The embodiments described herein, therefore, are not limited to the type of fluid that is being flowed through a system.

There is also no limitation on how the correlations between flow rate and other information may be stored. In an exemplary embodiment the correlation may be stored using one or more look up tables (“LUTs”). Although the use of LUTs should not be viewed as limiting as other ways to correlate information are available, for simplicity the embodiments herein are described using LUTs. However, nothing in this specification is intended to limit the disclosed embodiments to only use LUTs.

In an exemplary embodiment a fluid system is implemented with a flow regulator such as a set of one or more valves that may be operated via motors or other means, one or more motor pumps or combinations thereof. Flow rate readings may be recorded under controlled conditions and correlated to the specific operation of the flow regulator.

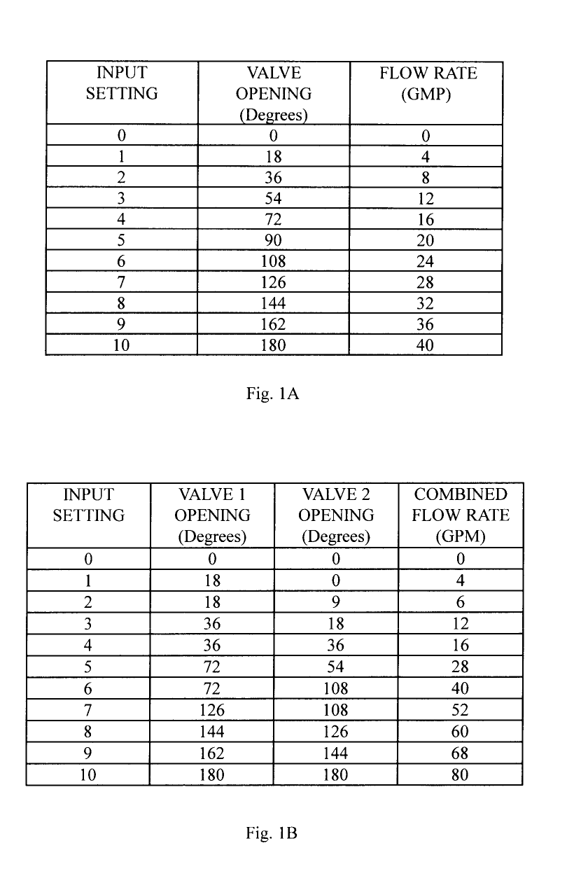

For example, in an embodiment in which the flow regulator is a single valve, readings of the fluid flow rate may be recorded for different input settings that correspond to different stages of the valve opening. These readings could then be recorded into one or more LUTs that correlate the degree of opening of the valve to the resulting flow rate. In an exemplary embodiment, as shown in FIG. 1A, the readings could be taken at equal intervals set in accordance with the desired level of monitoring or control for the specific application. FIG. 1A exemplifies ten settings corresponding to equal intervals of valve openings that provide differing flow rates. For a system in which a greater degree of flow monitor or control is desired, readings could be recorded more frequently and at shorter intervals. In an exemplary embodiment, a flow rate reading could be recorded for every degree or half degree or even tenth of a degree of valve opening. For applications where lower level of flow monitoring or control is acceptable, fewer readings could be recorded at larger intervals. For example, a reading may be recorded for every few degrees, such as every forty five degrees, or ten degrees or fifteen degrees or twenty degrees of valve opening. The interval of opening degree is not limiting and could selected depending on the desired level of monitoring or control for the specific application.

Similar flow rate readings could also be recorded with operation of multiple valves and/or the operation of one or more motor pumps. More details on these exemplary embodiments will be described below.

One direct way to gather the various readings is by actually measuring the flow rate, for example, by using a flow meter. Another method to gather readings may be to mathematically compute the flow rate based on the system characteristics such as pressure, volume, temperature, and other relevant information typically used to calculate a flow rate of a specific fluid. In an exemplary embodiment, the readings may be gathered through extrapolation based on a subset of actual or mathematically derived readings. Any one of the above methods or combination thereof may also be used. For simplicity, for purposes of the exemplary embodiments described herein, it assumed that the readings are gathered through direct measurement using flow meters. However, such methodology should not be viewed as limiting. Other information that can be related to the flow rate may also be gathered either by mathematical computation, direct measurement, or a combination of computation and direct measurement.

Once the recorded readings are gathered, the correlations may be stored in a memory device that can be accessed by a controller during operation. The memory device is not particularly limited and can be any type of memory storage device that can be accessed by the controller. One example of memory storage device may be one based on microelectromechanical system technology (“MEMs”). Another example of a memory storage device may be one based on of flash memory technology. Other types of memory may be used. In an exemplary embodiment, based on the desired settings, the controller may then select the operation setting of the flow regulator recorded, for example, in the one or more LUTs and achieve the prerecorded flow rates. The correlated information may also be used to monitor the system operation conditions for a given setting, such as current flow rate based only on information relating to the flow regulation system.

As explained in more detail below, the system may be able to ascertain the operation of the flow regulator. Importantly, however, although it could be equipped with one, the system would not require a flow meter to determine the flow rate and other system information. Instead, in exemplary embodiments the controller would be able to monitor and/or control the desired system conditions based on the feedback from the flow regulator, for example, the opening state of the one or more valves or the relayed signals to the one or more motor pumps.

During operation, a user could access system control to request a desired setting using any type of input device. The input device is not limited to any specific embodiment. It can be any device that is able to receive an input command from a user and transfer the command to the controller. An exemplary input device is described in U.S. Patent Application Publication No. 2011/0093099 the disclosure of which is incorporated herein by reference. The input device could be directly connected or even integrated into the controller or be a wireless device. The input operation could be implemented through mobile applications, touch screen devices mobile and fixed, actual system dials, or other means known in the field to input a command by a user. In an exemplary embodiment the input unit may be a separate standalone unit. The input settings would then be used by the controller unit to set the operation settings of the flow regulator.

The controller system is also not limited to a specific embodiment. The controller could be designed to fit the specific application. In an embodiment in which the flow control relates to a simple application the controller may consist of a very simple and inexpensive design. In more complex systems, the controller could include a much more sophisticated logic design. The level of computerization and logic used by a controller should not be viewed as limiting for the purposes of this application.

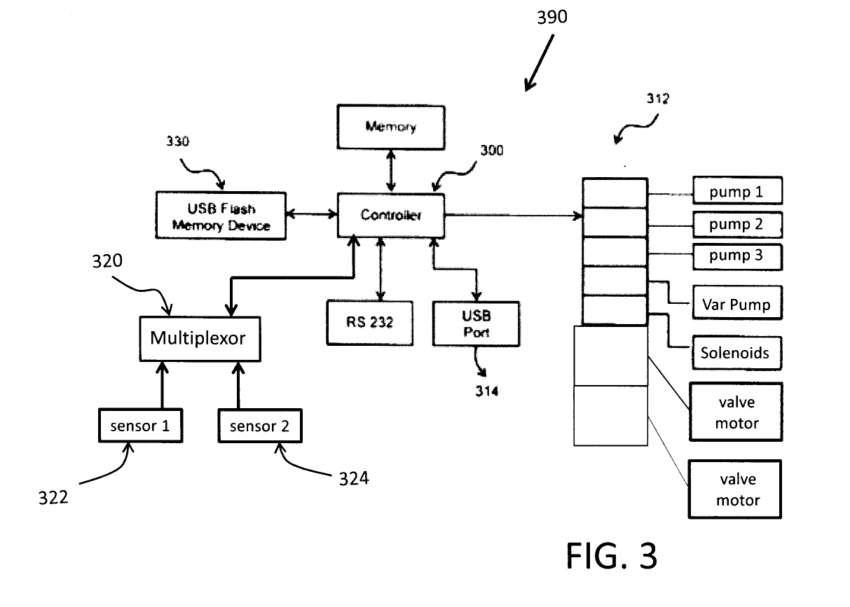

FIG. 3 illustrates a block diagram of an exemplary control system 390. The control system 390 includes a controller 300 where various sensors can be coupled to the controller 300. In one embodiment, the control system 390 uses a motorized diverter valve to control fluid flow. The exemplary control system 390 is coupled to at least one sensor module comprising a multiplexer 320 and one or more sensor monitors 322/324 that provides accurate valve position feedback to the controller 300. The control system 390 may also have one or more pumps, one or more valve motors, and one or more solenoids that are controlled by the controller 300 by way of a sub-controller 312 which may comprise both a software application layer within the controller 300 (i.e., be physically part of the controller 300) and hardware such as relays and motor drivers. The control system 390 may also comprise a variable speed motor controller. The determination of which devices are to be controlled by the controller 300 is dependent on the specific embodiment currently being implemented by the controller. Exemplary operation of these components under the control of the controller will be described below.

In an exemplary embodiment, additional LUTs or other correlation systems could also be used to correlate additional flow rate dependent system information. Also different types of flow generated by different settings of the flow controller may be correlated. Through various correlations the controller system may be able to either control and/or monitor the overall system characteristics and other information that may be provided to a user by way of display or other means such as a printed report or by sound or combination of the three. The means to communicate system information should not be viewed as limited.

In an exemplary embodiment the additional information may include an indication of volume of fluid that has been transferred over a period of time. An embodiment may include information regarding fluid pressure. An exemplary embodiment may include information relating to overall system pressure caused by the fluid flow. An exemplary embodiment may include information relating to temperature of the system as affected by the flow rate. The type of information that may be correlated to the flow rate should not be viewed as limited and may be designed based on the desired application of the system. Any one or more of the above information may also be used alone or together for display or reporting or to further actuate other system devices.

In exemplary embodiments, a controller as described herein may also allow the ability to select a programmable variable flow rate over a desired period of time. The controller may then effectuate the changes by operating the flow regulator and monitor the results based on the prerecorded correlation values and provide the variable flow rates over time automatically so as not to require manual operation and/or adjustment. Also, given a specified input setting it is possible to obtain information regarding system operation. For example, as shown in FIG. 1A at a given setting, which from a user perspective may be a simple selection of settings 0 to 10 with 0 being no flow and 10 being the highest flow, it may be possible to obtain the system operation information such as flow rate and other information based on the set of prerecorded correlations. Thus, the system may provide a simplified input setting for the user and still provide accurate information about the system operation.

For illustrative purposes only, below are provided some exemplary detailed embodiments on how the system may be implemented. The below described exemplary embodiments include motorized systems, pressure flow system, and a solenoid system.

Motorized systems include systems that involve the control of one or more motors. Such motors may be used to control valves and/or to pump fluid. The below are exemplary embodiments of these types of motorized systems. These examples are provided for illustrative purposes only. Combinations and/or variations of the below systems may also be implemented.

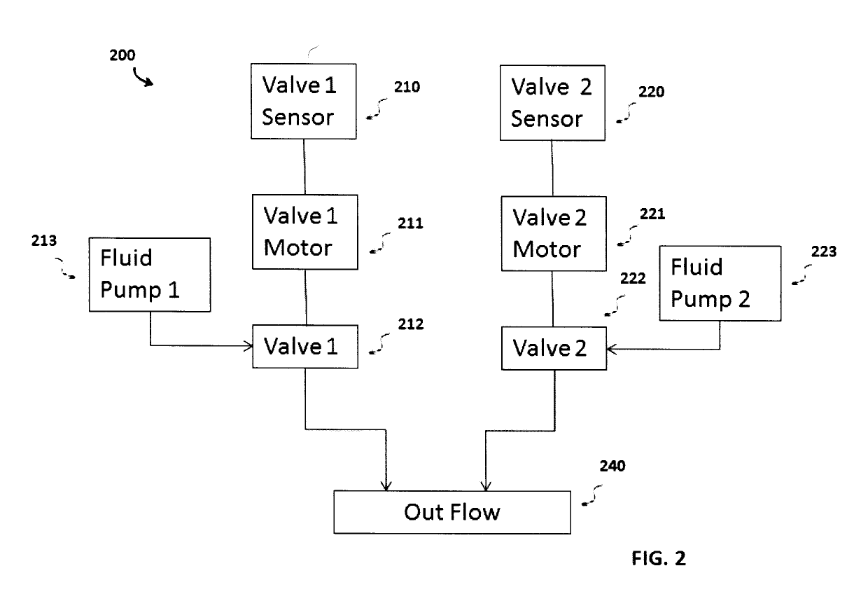

In an exemplary embodiment, one or more motors may be used to operate one or more valves to control the flow rate of a fluid. An exemplary embodiment 200 is shown in FIG. 2 in which the fluid reaches out flow 240 after passing through a system that includes two valves 212 and 222 each optionally located downstream from one or more pumps 213 and 223. Each valve may be operated by a motor 211 and 221. Any type of valves may be used. For example, the valve may be a ball valve, butterfly valve, diaphragm valve, gate valve, globe valve, needle valve, pinch valve, piston valve and etc. Other types of valves may also be used. In an exemplary embodiment the valves used are jandy valves.

The motors operating the valves are also not particularly limited. Motors that operate valves are well known in the art. Any motor may be used. In an exemplary embodiment, the motor used may be valve actuator by Hayward (Clemmons, N.C., USA), Model #GVA-24.

Coupled to each motor and valve pair may also be a smart sensor 210 and 220 that is able to read the degree of opening of the valve. In one exemplary embodiment, the sensor may include a rotor that is connected to the valve motor. In such exemplary embodiment, as the motor opens the valve it may also turn the rotor of the sensor thereby allowing the sensor to register the degree of opening of the valve.

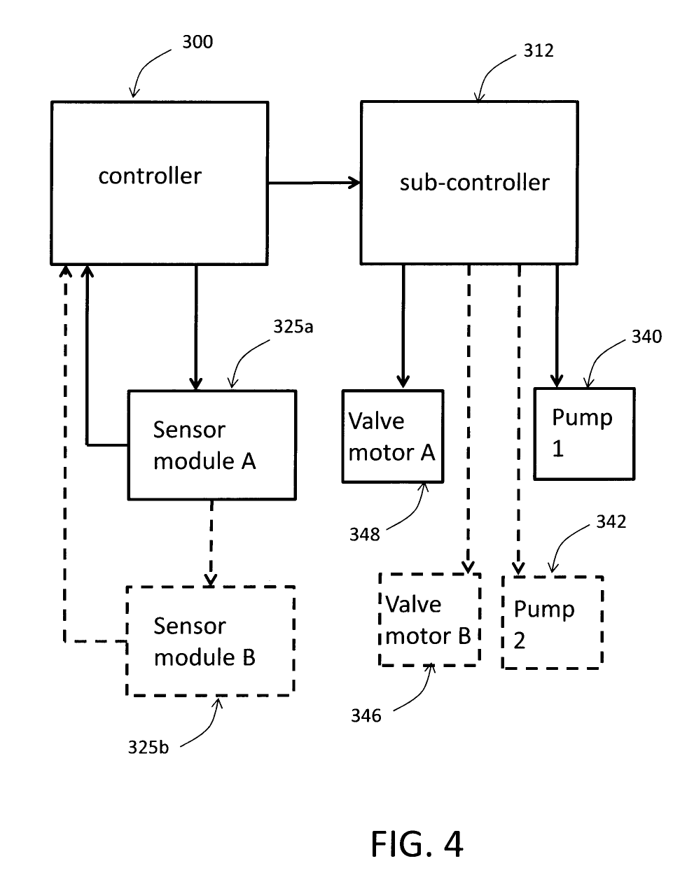

The sensor of each valve may be in communication with the controller and with any other sensor used in any additional valve. In an exemplary embodiment, the system is such that the controller communicates with a first sensor, that first sensor then communicates with a second sensor, and that second sensor communicates back to the controller. A schematic view of an exemplary embodiment involving two valves and corresponding sensors as described above is shown in FIG. 4 (the second valve, pump, and sensor are shown in dashed lines because they are optional in at least one embodiment).

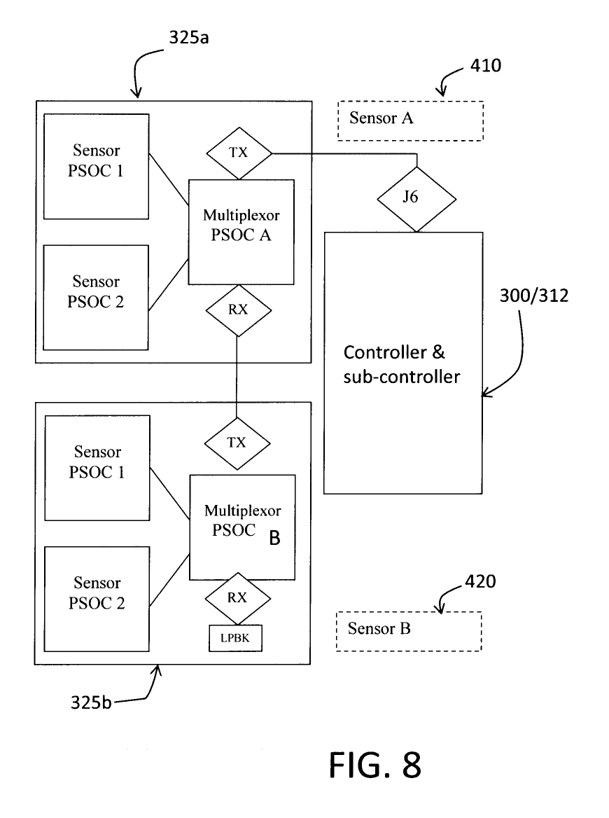

As shown in FIG. 8, the controller and the two sensor modules 325a/325b (defined as the sensor or sensors, monitoring electronics to detect the sensor(s)′ signal, and multiplexing electronics to package the signal data for communication to the controller) are connected in series, and as explained in more detailed below, the controller requests a reading to a first sensor module, that sensor module sends its reading to a second sensor module, the second sensor module provides its own reading and sends it along with the reading from the first sensor module to the controller.

Based on the readings from the sensors, it is possible to understand the flow regulator conditions which in turn may provide a basis for the controller to manipulate further, if necessary, the motor operation that opens and closes the valves so as to achieve the desired result or input setting. Notably, in this exemplary embodiment, the controller bases its determination of whether to open or close the valves on the sensor readings that correspond to the degree of opening of the valve and not to a measure of flow rate.

As previously described, correlations between system characteristics may be recorded based on input settings and/or various degrees of valve opening. In embodiments involving a system with more than one valve, the correlations may also be based on a combination of degree of openings from the multiple valves. For example a correlation may be drawn between the flow rate of fluid through each valve based on that valves degree of opening. Also, a correlation may be drawn between the total fluid flow rate and the degree of opening of the various valves. Another value that may be correlated is turbulence and as a function of the degree of opening of the one or more valves.

The correlations may be based either on calculated or interpolated values and/or on actual measurements. The number of correlations may lead to a more or less accurate control and/or monitoring of the system. For example, the more correlations the more precise the information that may be gathered. Thus, through various correlations, the controller may be able to achieve various level of control, and may be able to provide varying degree of information regarding the state of the system as a whole.

In exemplary embodiments the correlations may be made at set intervals of varying degree of opening of the one or more valves. Regular intervals as shown in FIG. 1A may provide a simpler and more direct control. However, the correlations may also be made at non-regular intervals if so desired. Varying applications may call for differing level of control and it is conceivable that a situation could arise where recording of correlation at non-regular intervals may be most effective. For example, the correlations may be made at a random degree of opening for the one or more valves. In another example, the correlations may be recorded at increasing intervals. For example, the correlations may be recorded at twice the degree of opening at which the previous correlation was recorded. In another example, the correlations may be recorded following a Fibionacci sequence with respect to degree of opening of the one or more valves. The granularity of the correlations may be limited only by the granularity of the position feedback sensor (i.e., the cap sense pads) discussed in more detail below.

Also, as exemplified in FIG. 1B, correlations may be recorded in multi valve system for intervals in which the various valves are opened at differing degrees. The correlations that may be created are not limited other than by the ability to register the opening of the valves by the sensors, and may be determined based on the particular application.

A schematic overview of an exemplary embodiment in which flow control is managed by a motorized diverter valve with position feedback control is shown in FIG. 4. The sub-controller controls a first pump 340, a first valve motor 348, an optional second pump 342, and an optional second valve motor 346. A first sensor module 325a and an optional second sensor module 325b are in communication with the controller 300 to provide an indication of the position of the respective valve openings. The determination of flow rate to valve opening and input setting will be pre-recorded in a non-volatile memory in the form of a look-up table, preferable a USB flash memory device, at the control system 390. The user may then use a control panel to input the operation parameters of the devices (for example, the desired flow rate or simplified setting). Details of the control panel, as well as other relevant aspects of the controller 300 are disclosed in U.S. Patent Application Publication No. 2011/0093099, incorporated herein by reference for all purposes.

The control system 390 may also have a serial and/or parallel input and/or output port for communicating with the outside environment. As an example, the serial or parallel port may provide for Internet communication channel with the control system 390. The control system 390 may also have a USB port 314 and/or wireless communication interface (not shown). As an example, the USB port 314 and/or wireless communication interface may allow for a diagnostic device to have access to the control system 390 in order to obtain information, for example, regarding operations or cause of malfunctions of the control system, or simply perform diagnostic routines on the control system 390. It should emphasized that the usage of the ports is not limited to those described above. As an example, the ports could be used to couple audio and/or video devices to the control system 390.

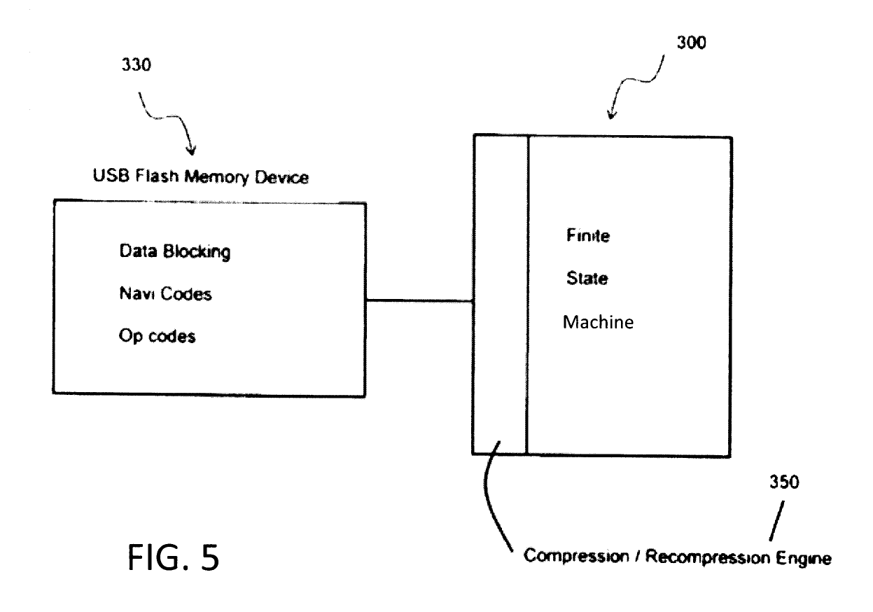

Referring now to FIG. 5, the controller 300 may be formed in a field programmable gate array (FPGA). However, the controller 300 can be formed using application specific integrated circuits (ASICs), complex programmable logic devices (CPLDs), or other suitable integrated circuit devices.

The controller 300 is a finite state machine that transitions to a state in a finite number of states where each transition occurs due to a triggering event. Simply put, the finite state machine is driven by events. For instance, an event may be triggered by an input signal from a user through the control buttons located at the control panel. Events may be triggered by periodic time signals where each event is triggered by each time signal sent by a clock included in the control system that represents time of day. An event may be triggered by a signal sent at a predetermined time based on a programmed event, for example, a “wake-up” signal to cause the control system to wake-up from dormancy in order to circulate water in the spa system, for example. Each event causes finite state machine to transition from a current state to another state, or in some cases, the finite state machine does not transition to another state but returns to the current state. There are many action types in the finite state machine such as “entry action” where an action is performed when entering a state; and “exit action” where an action is performed when exiting a state. Usually, the finite state machine described above performs entry action. However, the finite state machine need not be limited to this type of action.

In the present embodiment, any one or more of blocks of data that represent text and/or graphic image, navigational data block, and opcode sequences that are arranged to produce executable binary codes constitute an action that can be triggered by an event. The data blocks could be graphical and text images. the navigational data block could be pointers to a background layer, foreground layer, and/or sprites layer (these layers will be discussed below). Also, the navigation data block could be pointers to the next state. The navigation data block could be a pointer to a sequence of opcodes or a pointer to a register value that could be a link to the opcodes. In other words, the navigation data block is used to find various data in a memory and/or provide pointers to the next state, for example. Since the finite state machine is a structure composed of a finite number of states to transition between, the characteristics of the controller is defined by the blocks of data that represents text and/or graphic image, navigational data block, and opcode sequences, which in this embodiment, are stored in a USB flash memory device 330 such as a memory stick that couples to the controller through a USB port.

Depending on the amount of data, navigation data, and opcodes that need to be stored in the USB flash memory device, the controller may further include a decompression engine 350 with an presumption that the data and the opcodes are compressed prior to being stored in the USB flash memory device 330. Thus, when an action is retrieved from the flash memory device, prior to being acted on, the action is first decompressed by the decompression engine 350 and then executed. The decompression engine 350 can be formed with the finite state machine in the FPGA and can adopt any one of the well-known data decompression algorithms. As discussed above, certain irregularities in the operation of the spa system may cause the control system to log those irregularities in an event log that is stored in the USB flash memory device, for example. In order to conserve memory space in the USB flash memory device, the controller may further include a compression engine 350 to compress data representing the irregularities that occurred during operation. The compression engine 350 can be also formed in the FPGA and can adopt any one of the well-known data compression algorithms. Additional details regarding the features and function of the finite state machine based controller 300 are disclosed in U.S. Pat. No. 8,533,763, incorporated herein by reference for all purposes.

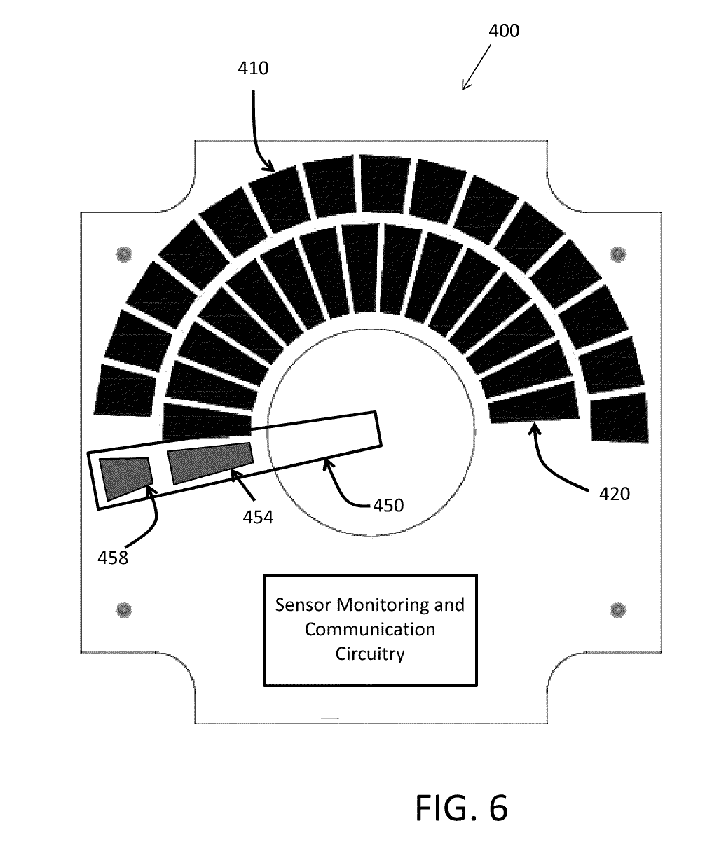

The above-mentioned motorized diverter valve module comprises a valve motor and a sensor module. In at least one embodiment there are two valve motors to regulate two fluid flows and two sensor modules one for each diverter valve. As shown in FIG. 6, the sensor 400 itself comprises two rows of isolated electrical contacts 410 and 420 (e.g., copper), also referred to as “cap sense pads” positioned along two arcs co-centered around the diverter valve. The illustrated shape of these pads are an exemplary embodiment and should not be considered limiting to the claimed invention; a plurality of different shapes, providing different capacitance characteristics are contemplated by this disclosure. For clarity, these two arcs can be referred to as ‘sensor 1’ 410 and ‘sensor 2’ 420. The diverter valve is opened and closed by a motor. A wiper 450 with two separate contact pads 454/458 has a rotor which is coupled to the motor and rotates along with the diverter valve to sweep through the two above mentioned arcs. There is a natural capacitance between each of the adjacent isolated electrical contacts 410/420 which is monitored and which changes as the wiper 450 contacts 454/458 pass through each arc of cap sense pads 410/420. The associated change in capacitance between relative contacts is translated into an accurate position of the wiper 450 and thus the correlated percentage of valve opening.

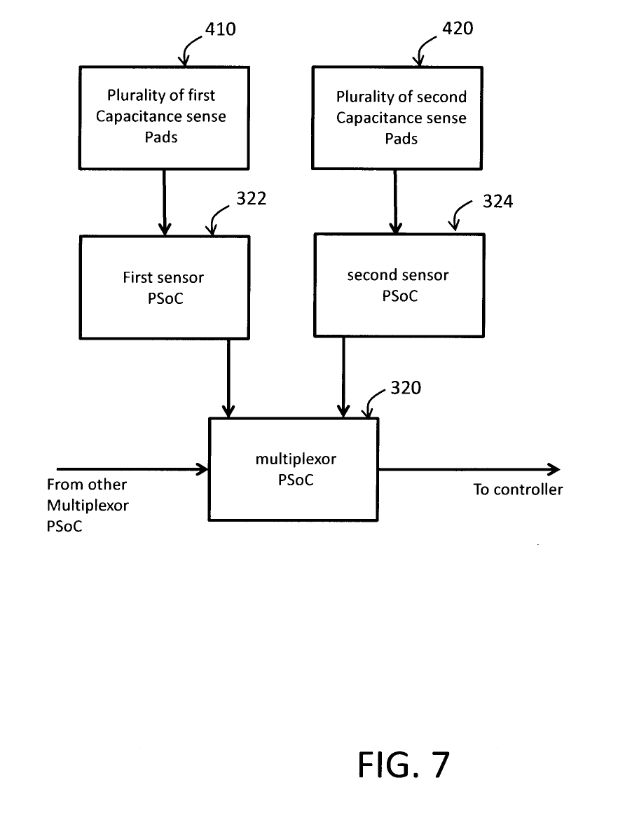

As shown in FIG. 7, the contact capacitance within each arc (‘sensor 1’ and ‘sensor 2’) is monitored by an respective programmable system on a chip—Sensor_PSoC1 (322) and Sensor_PSoC2 (324). While potentially any programmable integrated circuit could perform this function, this exemplary embodiment utilizes the CY8C21434 by Cypress Semiconductor (San Jose, Calif., USA). The data monitored by Sensor_PSoC1 322 and Sensor_PSoC2 324 is then communicated to another PSoC, in the exemplary embodiment another CY8C21434, and multiplexed together. This multiplexing PSoC 320 is identified as multiplexor_PSoC_A. This multiplexed data can then be communicated to the controller to identify the position of the diverter valve. If the divert valve is not in the position for the desired flow rate, then the controller can energize the valve motor to either open or close the valve. As the valve opens or closes, the position is fed back to the controller until the desired position is obtained at which time the valve motor is de-energized.

While one flow regulator may be sufficient in one embodiment, there is more than one flow regulator needed, for example for two separate flows and will be further described herein. Each of the flows is controlled by a separate diverter valve, and therefore each have a unique sensor or pair of sensors, sensor PSoC, and multiplexor PSoC as described above. For clarity, the second set of flow control circuitry carries a ‘B’ identifier. In order to conserve inputs to the controller, the two separate sensor modules (i.e., A and B) are daisy-chained together as illustrated in FIG. 8.

FIG. 8 shows the interconnections between the various microprocessors. The sensor/multiplexor set 325a connected to the controller is designated Sensor module A. The sensor/multiplexor set 325b connected to Sensor module A is designated Sensor module B. FIG. 8 shows a block diagram of the hardware architecture. Note that Sensor module B has a loopback input at its RX communication port. This loopback plug enables the controller to transmit a command to multiplexor_PSoC_B. The controller receives data from multiplexor_PSoC_A. Multiplexor_PSoC_A receives data from multiplexor B through the receiver designated RX. Each multiplexor PSoC receives sensor data from two sensor PSoCs, designated 1 and 2. The data interface between the sensor PSOC and the multiplexor PSOC consists of a unidirectional bus. The multiplexor PSOC can only receive data from the sensor PSOC. The sensor PSOC encodes data from the cap sense pads. The data indicates which pad is currently sensing the wipe 450. The multiplexor PSOC polls the sensor PSOCs. On receipt of a read command, the multiplexor transmits the sensor data for the associated sensor_PSOC1 and sensor_PSOC2. The values sent are the latest values read from the sensor PSOCs.

The controller executes op code chains. These op code chains perform the application level functions required to operate and manage the flow control function including operating the diverter valve and monitoring the valve position utilizing the sensor modules.

To implement the valve control, sensor feedback embodiment illustrated in FIG. 4, the controller responds to a unique opcode to signal the start and end of a sensor polling session. While not limited to the following example, the op code may have the following format:

| Byte Offset | Value | Description |
|---|---|---|
| 00 | 01 | Op Code Type |
| 01 | 0x52 (82 decimal) | Op Code Function ID |
| 02 | 0 | Unused |
| 03 | 0 | Unused |
| 04 | 0 = OFF; 1 = ON | Polling Boolean |
| 7-15 | 0 | Unused |

When the controller encounters the unique flow control op code during an op code chain execution, the controller will take action according to the state of the polling Boolean. If the Boolean is set to 1, the controller will store the sensor data in memory. As an example, the sensor data may be saved in the following memory space of the controller:

| | |
|---|---|
| 01F0x80C9 | Sensor A Flow Control |
| 01F0x80CA | Sensor B Flow Control |

At the start of the polling session, the controller determines the direction of motion for both sensors. The controller sends each sensor a directional command to enable the sensors to produce monotonic readings. There are two directional commands for each sensor, one for incrementing the position, and one for decrementing the position. Each command will have codes that identify the unique sensor to control and the direction of control. In one example, the command may be “AD” or “AI” signaling the A sensor to move in a direction producing decreasing values (for “AD”), and in a direction producing increasing values (for “AI”). Commands for the B sensor may for example be “BD” or “BI”.

The controller will set the initial value of the sensor locations to 0xFF to indicate no data has arrived. During a polling session, the controller will poll Sensor module A periodically. When the controller encounters the op code for valve control, sensor feedback with a Boolean value indicating the OFF state, the updating of sensor variables will be disabled.

The communication links between the controller and Sensor module A are half-duplex. The controller operates primarily as the master device, although the controller can receive updated data whenever Sensor module A transmits it. At system initialization, or when it encounters an opcode to activate sensor polling, the controller sends an update command to multiplexor B. Upon receiving the update command, the multiplexor PSoC for sensor module B sends an update of data which is received by the multiplexor PSoC for sensor module A. Multiplexor A in turn transmits updated data to the controller.

Sensor module A sends the controller updated data comprising a message header, the sensor value for sensor module A, the sensor value of sensor module B, and a checksum, e.g., consisting of the sum of the values for each of sensor modules A and B. This data may take the form of a packeted string, for example, “rNMC\n” where “r” is the message header; N is the sensor value for Sensor module A; M is the sensor value for Sensor module B; and C is the checksum, consisting of the sum of M and N. Sensor module B sends an update data packet consisting of a similar string “rNMC\n” where “r” is the message header, N is the value of Sensor module B; M is a dummy value and C is the checksum, consisting of the sum of M and N.

Multiplexor PSoCs A and B will share common code. Each multiplexor PSoC determines its operational behavior by the initialization command it receives. The following sections describe the multiplexor_PSoC_A and multiplexor_PSoC_B functional behavior.

Multiplexor_PSoC_A Functional Behavior

Multiplexor_PSoC_A connects directly to the controller. Multiplexor_PSoC_A can only receive from multiplexor_PSoC_B and can only transmit to the controller. Multiplexor_PSoC_A has the following functional behavior:

1. multiplexor_PSoC_A polls sensor_PSoC1 for a button/sensor pad code

if a code is pending, it enters the decoding state machine to receive the code. It stores the code in a variable named LocalSensorCode.

2. multiplexor_PSoC_A polls sensor_PSoC2 for a button/sensor pad code

if a code is pending, it enters the decoding state machine to receive the code. Due to the layout of the sensor pads, multiplexor_PSoC_A converts the inputs it receives from the sensor 1 as odd numbered values by multiplying the value it receives by two and adding one. For sensor 2 it multiplies the value it received by two. It stores the converted value in the variable named LocalSensorCode. When both sensors produce updates, the multiplexor PSOC selects the value that is consistent with the defined direction of motion. If the multiplexor had received a decrement position command, it selects the lesser of the two values for transmission. If the multiplexer had received an increment position command, it selects the greater of the two values.

3. multiplexor_PSoC_A polls the receiver connection for a pending packet. If Sensor module B sent a packet, multiplexor_PSoC_A validates the packet. It then updates its local variable holding the Sensor B data.

4. If either, or both of the sensors reported a new value; or if multiplexor_PSoC_A received an update packet from multiplexor_PSoC_B, multiplexor_PSoC_A formats an update packet and transmits it to the controller. As a safeguard, multiplexor_PSoC_A transmits the packet an additional three times unless it receives new input from its sensors or multiplexor_PSoC_B.

Multiplexor_PSoC_B Functional Behavior

Once the identity of multiplexor_PSoC_B is established, multiplexor_PSoC_B enters a polling loop with the following steps:

1. multiplexor_PSoC_B polls sensor_PSoC1 for a button/sensor pad code

if a code is pending, it enters the decoding state machine to receive the code. It stores the code in a variable named LocalSensorCode.

2. multiplexor_PSoC_B polls sensor_PSoC2 for a button/sensor pad code

if a code is pending, it enters the decoding state machine to receive the code. Due to the layout of the sensor pads, multiplexor_PSoC_B converts the inputs it receives from the sensor 1 as odd numbered values by multiplying the value it receives by two and adding one. For sensor 2 it multiplies the value it received by two. It stores the converted value in the variable named LocalSensorCode. When both sensors produce updates, the multiplexor PSOC selects the value that is consistent with the defined direction of motion. If the multiplexor had received a decrement position command, it selects the lesser of the two values for transmission. If the multiplexer had received an increment position command, it selects the greater of the two values.

3. multiplexor_PSoC_B polls the receiver connection for a pending command. If a command is pending, it reads the command.

4. If either, or both of the sensors reported a new value; or if multiplexor_PSoC_B received an update command from the controller, multiplexor_PSoC_B formats an update packet and transmits it to multiplexor_PSoC_A. As a safeguard, multiplexor_PSoC_B transmits the packet an additional three times unless it receives new input from its sensors or another update command from the controller.

The firmware executing in sensor_PSoC1 and sensor_PSoC2 has no knowledge of which it is. The connection of the Sensor PSOC to the multiplexor PSOC determines its identity. The Sensor PSOC scans the cap sense pads to detect the position of the wiper. If no pads are active, the sensor value is set to a certain value (e.g., 0x1F), indicating no code or the state is undefined. When the Sensor PSOC senses activity on a pad, the firmware determines which pad is active and enters the state machine to transmit the code to the multiplexor PSOC. The Sensor PSOC will transmit a value ranging from zero to X, wherein X is the number of cap sense pads minus one.

As discussed earlier, the flow rate achieved through the input setting is correlated in advance to the degree of valve opening. Thus, the system may provide information relating to flow rate based on the prerecorded correlations. Similarly, the system may provide other prerecorded or extrapolated information using the correlations based on the reading from the sensors, without having to actually measure such information. For example, the system may be able to provide information regarding turbulence, amount of fluid that has flowed through the system, pressure caused on the system, fluid pressure. Through the design and use of correlated information there are numerous options and applications that may be particularly addressed. Thus, the embodiments described herein should not be viewed as limited to providing information regarding flow rate.

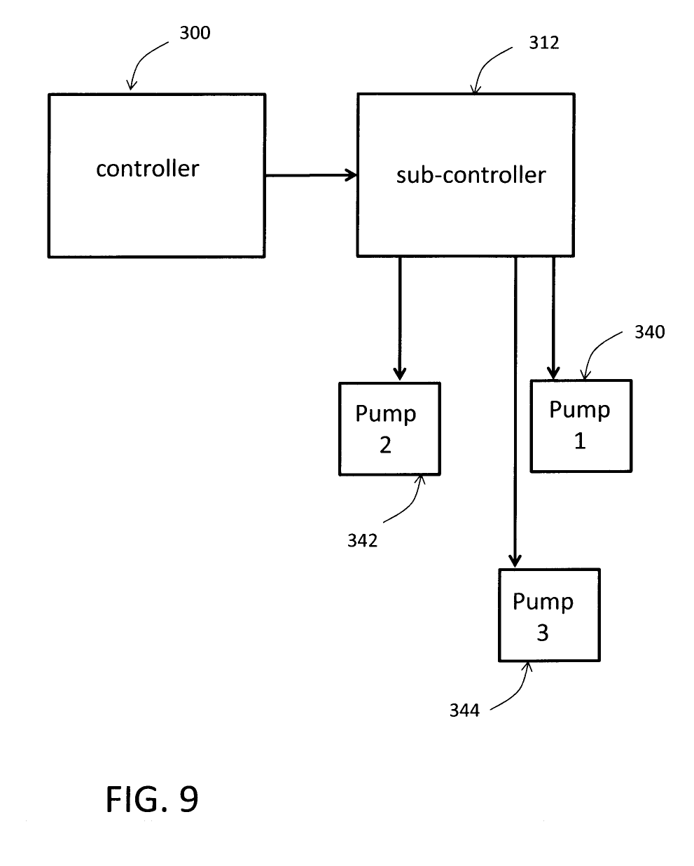

In another embodiment, as shown in FIG. 9, instead of a diverter valve being used to regulate the flow, a plurality of pumps 340/342/344 are controlled in combination to produce a desired output. Thus, in place of the one or more valves as described in the previous embodiment, the flow regulator is implemented as a set of motor pumps. The motor pumps may all feed into a single fluid conduit. Alternatively, each motor pump may control the fluid flow through a given conduit. The operation of the system would similar as discussed previously, except that there may not be a need to have a sensor that provides information relating to a valve back to the controller. Instead, the controller would set the desired flow rate by operating the one or more motor pumps. As the motor pumps may be operated simply by relaying a signal to them, the controller would not require a sensor able to feedback the operation of the one or more motor pumps. This information would be already with the controller and can be used like the signals received by the sensors discussed previously.

In a simplified exemplary embodiment the system could include three motor pumps 340/342/344, each motor pump having two three settings, not in operation (“OFF”), in operation at a low rate (“LOW”), and in operation at a high rate (“HIGH”). All three motor pumps may be arranged so as to affect fluid flow through a single conduit or pipe. As done with the valve system discussed previously, a series of correlations for different input settings may be recorded based on the operation of the three motor pumps. For example, flow rate may be measured when two of the motor pumps are in the OFF state and one motor pump is in the LOW state. Another correlation may be recorded when the one motor pump is instead in the HIGH state. Another correlation may be recorded when one motor pump is OFF, one is LOW, and one is HIGH. Another correlation may be when one motor pump is OFF and the other two are both LOW. Another correlation may be when all three motor pumps are in the LOW state. Another may be when all three motor pumps are in the HIGH state. Other correlations may be recorded based on which motor pumps are operating. It is readily apparent that various combinations may be recorded. Any and all possible combinations are within the scope of the invention and may be recorded. As before, these correlations may also be stored by way of one or more LUTs or other manner that would retain the correlation and stored in a memory device, such as a MEMs. Also, correlations relating to features other than flow rate may also be correlated such as total volume, fluid pressure, system pressure, as well as other information that can either be interpolated, calculated, derived or actually measured.

Based on the correlated pre-recorded information, the controller may then operate the appropriate combination of motor pumps based on the desired system operation. Based on the correlated information, the system would then also be able to provide information regarding various system conditions for any given input setting without having to rely on feedback from actual sensors such as flow meters and like devices.

For example, in response to a user selected input setting, the controller may derive one or more relay signals for the operation of the one or more motor pumps. The controller may then instruct a sub-controller such as relays, motor drivers etc. . . . to operate the motor pumps in accordance with the determined relay signals. For example, in an exemplary embodiment as discussed above involving three motor pumps capable of only three settings, the relay signal may result in the operation of one motor pump sent on HIGH, one motor pump set on LOW, and one motor pump set on OFF. Unique to this process is that based on the one or more relay signals obtained through the above described operation and the prerecorded correlations that may be stored in LUTs, the controller may also be able to determine the system operation such as flow rate of the fluid or any other prerecorded correlated information. In this manner, the system may be able provide microprocessor automated monitoring and/or control based only on user input.

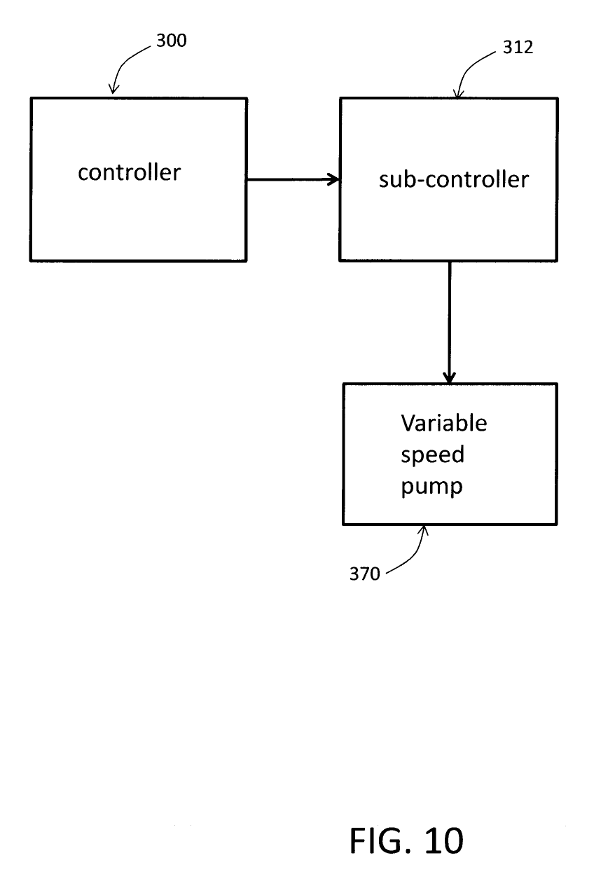

Another exemplary embodiment, as illustrated in FIG. 10, also may be implemented using a one or more variable motor pumps 370 as the flow regulator. Thus, instead of having a simplified motor pump that can only have a low or high setting when operating, a variable motor pump may provide various settings that may be controlled by varying the relay signal sent to the motor pump. For example, a relay signal could be varying in increments of 0.5 V to achieve in response varying flow rates at every interval.

In an exemplary embodiment using a variable motor pump the system may be operated in the same manner as one with a single valve as described before. Instead of correlating flow rate and other information based on degree of opening of the valve, however, the correlation may be based on the relay signal to the motor pump. Thus, as before correlations could be based on either constant intervals, random intervals or other predetermined intervals. For example, correlations may be based on the relay signal changing every 0.5 V. In another example, the correlations may be recorded based on every 1 V. Alternatively, the correlations may be recorded every 2 V. Alternatively, the correlations may be every 5 V. Also, the correlations may be random, such as 0.5 V, 2 V, 3 V, 7 V, 9 V, 15 V, and etc. Alternatively, known series such as the Fibionacci series may be used. Like variations of degree of openings for a valve, there are numerous different ways that correlations may be recorded based on varying relay signals. Also, the system may include multiple varying motor pumps and thus correlations may be recorded based on the motor pumps receiving the same or different relay signals.

With the pre-recorded correlations stored and accessible by the controller, the system can be operated in the same manner as described above with respect to the valve embodiment. Based on a selected input setting, the system, having the information regarding the relay signal sent to the varying motor pump or motor pumps, may be able to provide information regarding system conditions such as flow rate, without requiring an actual sensor like a flow meter to measure such conditions.

For example, in response to a user selected input setting, the controller may derive one or more relay signals for the operation of the one or more variable motor pumps. The controller may then instruct a sub-controller such as relays, motor drivers etc. . . . to operate the variable motor pumps in accordance with the determined relay signals. For example, in an exemplary embodiment as discussed above involving one variable motor pump, for a given input setting the relay signal may correspond to a signal of 4 V. As described previously, unique to this process is that based on the one relay signal obtained through the above described operation and the prerecorded correlations that may be stored in LUTs, the controller may also be able to determine the system operation such as flow rate of the fluid or any other prerecorded correlated information. In this manner, the system may be able provide microprocessor automated monitoring and/or control based only on user input.

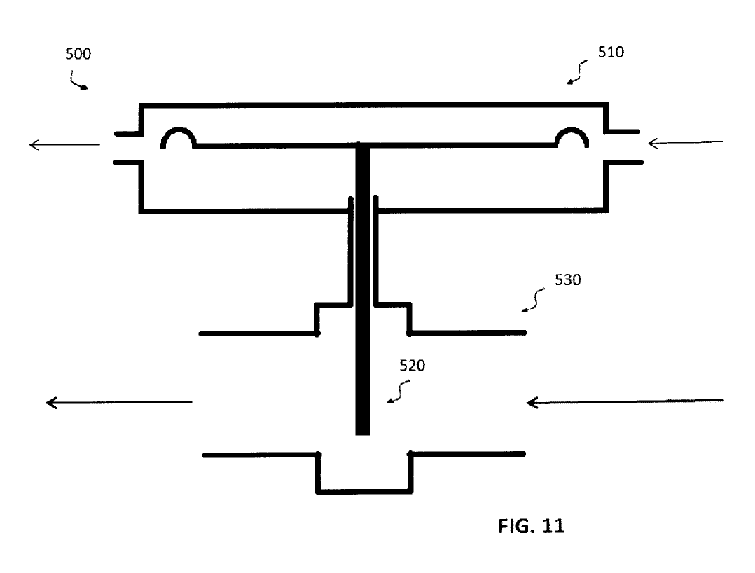

In yet another exemplary embodiment the system may be implemented without the use of a motor. Instead, the flow regulator may be implemented through the utilization of a pressure flow apparatus such as a diaphragm. The system may be designed to include a diaphragm responsive to the fluid pressure. As illustrated in the diagram 500 of FIG. 11, not drawn to scale, the system may be designed to include a diaphragm 510 responsive to fluid pressure. As the pressure of the fluid changes, the diaphragm may oscillate. The diaphragm may be connected to a valve 520 in the path of the fluid flow conduit 530. Valve 520 would then open and close at varying degrees based on the pressure in the diaphragm. Thus, control of the fluid flow may be controlled and/or monitored using the diaphragm in place of a motor opening and closing a valve and thus affect flow.

Implementation of this latter exemplary embodiment is similar to the previous valve and motorized systems. Flow rate information, for example, may be correlated to pressure variations reflected by the displacement of the diaphragm. Thus, similar to the correlations described above in which flow rate and other information can be pre-recorded based on the degree of opening of a valve, in this exemplary embodiment similar correlations may be based on the pressure variations through the diaphragm.

A controller may then read the pressure change sensed by the diaphragm to characterize the overall system. As discussed previously, the correlated information may be actually measured. Alternatively, the information may be computed based on the system characteristics. Alternatively, the information may be extrapolated. Also, any combination of these methods may be used to identify the various correlations.

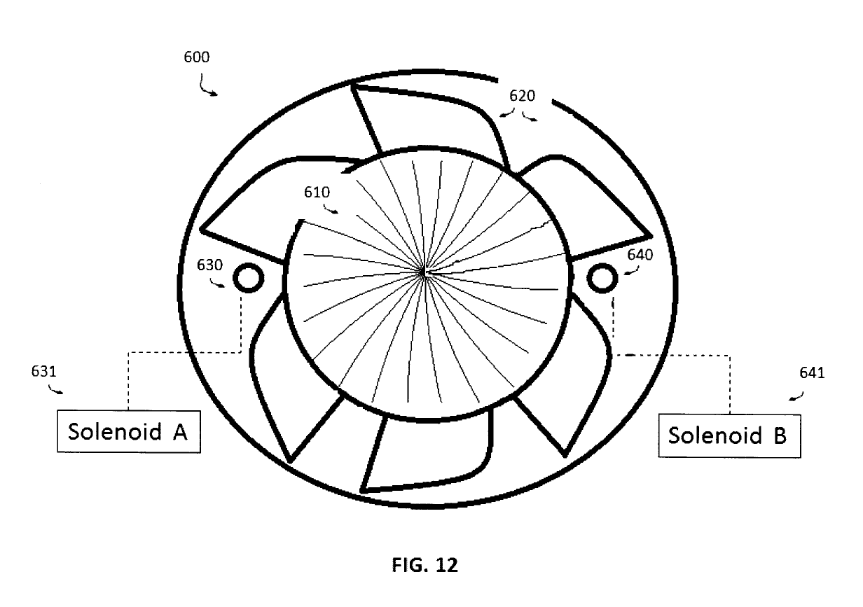

In yet another exemplary embodiment, the system may use an electrical means to operate the system. Thus, instead of a motorized or pressure based systems as discussed above, the fluid flow may be controlled and/or monitored through an electrical signal. In an exemplary embodiment, the flow regulator may include an iris valve equipped with fan paddles and operated by a solenoid apparatus. An exemplary illustration of such an apparatus 600 is shown in FIG. 12. The iris valve 610 may include fan paddles 620. The apparatus may also be provided with two orifices 630 and 640 that may be opened or closed using solenoids 631 and 641 respectively. When orifice 630 is opened, a fluid flowing through would case the fan paddles 620 to turn in a first direction that may cause the iris valve 610 to open. When orifice 640 is opened instead, fluid flow may cause the fan paddles 620 to rotate in the opposite direction and close the iris valve. Through operation of the solenoids, therefore, the valve may be opened or closed at various degrees.

As known in the art, a solenoid may be operated through the application of an electric signal. Thus, varying electric signals would allow for varying degrees of operation of the iris valve. Similar to the previously described variable motor pump embodiments, therefore, various correlations may be created based on the signal relay to the solenoid. Thus, as in the variable motor pump embodiment, the controller may be able to assess system conditions based on the pre-recorded correlations based on the relay signal sent to the solenoid.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for monitoring the conditions of a fluid being transferred comprising:
a flow regulator; and
a storage device comprising one or more pre-recorded correlations between settings of the flow regulator and conditions of the fluid being transferred;
wherein the conditions of the fluid being transferred are monitored based on the settings of the flow regulator using the one or more correlations.

2. The system of claim 1, wherein the flow regulator comprises at least one of valve, motor, motorized pump, diaphragm, and solenoid.

3. The system of claim 1, the storage device comprises a MEMs device.

4. The system of claim 1, further comprising a valve and wherein the flow regulator settings comprises a degree of opening of the valve.

5. The system of claim 4, further comprising a first sensor able to signal the degree of opening of the valve.

6. The system of claim 5, the first sensor further comprising a rotor connected to a motor that operates the valve.

7. The system of claim 5, the first sensor comprising:
a rotor;
a wiper connected to the rotor; and
one or more sense pads that determine the position of the wiper.

8. The system of claim 7, wherein the rotor is further connected to a motor that operates the valve and that turns the rotor by the same amount it opens or closes the valve.

9. The system of claim 8, further comprising a second valve and a second sensor able to signal the degree of opening of the second valve.

10. The system of claim 9, further comprising a controller.

11. The system of claim 10, wherein the controller, a first sensor module comprising the first sensor, and a second sensor module comprising the second sensor are serially connected such that the controller is able to send a signal to the first sensor module, the first sensor module is able to send a signal to the second sensor module, and the second sensor module is able to send a signal to the controller.

12. The system of claim 11, wherein the signals are only sent in one direction.

13. The system of claim 1, wherein the flow regulator settings comprise a relay signal.

14. The system of claim 1, wherein the flow regulator settings comprising a pressure drop registered by a diaphragm.

15. The system of claim 1, wherein the conditions of the fluid being transferred comprise at least one of flow rate, turbulence, and fluid pressure.

16. The system of claim 1, further comprising a controller with an output to provide system information.

17. The system of claim 16, the output comprising a display.

18. The system of claim 1, wherein the flow regulator comprises at least one valve and a motor to operate the valve.

19. The system of claim 18, wherein the series of correlations comprise valve opening settings and resulting fluid flow rate.

20. A method of monitoring the conditions of a fluid being transferred comprising:
providing a storage device comprising one or more pre-recorded correlations between settings of a flow regulator and conditions of the fluid being transferred;
sensing a setting of the flow regulator during operation; and
determining the conditions of the fluid being transferred based on the settings of the flow regulator using the one or more correlations.
